(19) United States
(12) Patent Application Publication
(10) Pub. No.: US 2008/0263254 A1
(43) Pub. Date: Oct. 23, 2008

(54) Method and System For Adjusting Bus Frequency And Link Width On A Bus

(75) Inventors: Yao-Chun Su, Taipei (TW); I Lin Hsieh, Taipei (TW)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: VIA TECHNOLOGIES, INC., Taipei (TW)

(21) Appl. No.: 11/738,402

(22) Filed: Apr. 20, 2007

(51) Int. Cl. G06F 13/36

(52) U.S. Cl. 710/310

(57) ABSTRACT

A computer system that includes a host bus connected between a processor and a Northbridge chipset. The Northbridge chipset monitors the host bus and adjusts the host bus frequency and bus link width according to monitored traffic conditions on the host bus.

### FIELD OF THE INVENTION

The present invention relates generally to computing systems and chipsets and, more particularly, to a method and system for adjusting bus frequency and link width on a bus.

### BACKGROUND

Today, computing system can include one or more central processing units (CPUs) or microprocessors to access and process data from any number of peripheral devices. The CPUs and peripheral devices are connected via data busses and can access data at high speeds. Such computing systems typically include one or more chipsets (controller circuitry) placed on the mother board, which handles data flow with the computing system and between the CPUs and peripheral devices, as well as from internal/external memory and data caches. A common chipset architecture is the Northbridge and Southbridge architecture. Northbridge typically refers to controller circuitry that communicates with one or more of the computing system's processors and controls interaction with memory and memory caches and graphics ports. Southbridge typically refers to controller circuitry that handles I/O or peripheral device functions to the CPUs. Each of these chipsets can be referred to as a hub for handling various functions for the motherboard.

In such computing system architecture, a host bus, such as the Front Side Bus (FSB) or HyperTransport (HT) bus, connects a CPU to a chipset—i.e., the Northbridge chipset, and provides high bandwidth operation and high performance applications. For example, the HT bus can provide 1 GHz/16-bit operation on a processor-to-chipset link. The HT bus is often considered a flexible, extensible, and a simple bus structure design, which is commonly implemented in many computing systems. A problem with operating at such high speeds and bandwidths is power consumption, thus, many computing systems provide power management applications. For example, for laptop computers or other portable systems, the operating voltages and/or frequencies of processors may be reduced to save power and increase battery life, and/or lower system temperature when the high processing speed is not needed. In contrast, the operating voltages and/or the frequencies may be increased when more processing tasks are demanded or when a high processing speed is needed.

An example of power management application in a computing system is the “PowerNow!®” technology developed by Advanced Micro Devices, Inc. (AMD) that monitors a CPU's operating condition such as its frequency and voltage. It can also change those parameters for the CPU. U.S. Pat. No. 7,073,082 to Hsu, entitled “Method for CPU Power Management and Bus Optimization,” provides an example where the CPU load can be detected by an operating system or by a driver to adjust the operating voltage and the frequency of the CPU. Furthermore, ACPI (Advanced Configuration and Power Interface) is another example of power management in a computer system. Conventional solutions frequently emphasize managing power consumption of processors and devices of the computer system. These solutions, however, do not consider power management of data buses coupled between the processors and devices.

Therefore, there may be a need to consider power management of a data bus and the ability to dynamically adjust operation parameters, such as the bus frequency and the bus link width, on the data bus.

### SUMMARY OF THE INVENTION

According to one example, a method for adjusting a bus frequency and bus link width of a host bus is disclosed. A bus monitor driver is installed to a Northbridge chipset. Traffic conditions of the host bus are monitored. The bus frequency and bus link width of the host bus are adjusted according to the monitored traffic conditions.

According to another example, a method may operate a computing system having a Northbridge chipset and adjust a bus frequency and bus link width of a host bus, which may be connected between a processor and the Northbridge chipset. A system management interrupt signal is triggered when an adjusting signal is issued. The values regarding a bus frequency and bus link width of the host bus are updated.

According to another example, a computing system may have a processor, a Northbridge chipset, and a host bus connecting the processor to the Northbridge chipset. The Northbridge chipset monitors traffic conditions on the host bus and adjusts at least one of a bus frequency and bus link with of the host bus according to monitored traffic conditions on the host bus.

According to another example, a computer readable medium containing instructions, which if executed by a computing system, may operate to perform: waking up a basic input output operation system (BIOS) in the computing system; storing values in one or more registers related to one or more operating parameters for a host bus; and operating the host bus based on the stored values in the one or more registers.

### BRIEF DESCRIPTION OF THE DRAWINGS

The accompanying drawings, which are incorporated in and constitute part of this specification, illustrate examples, implementations, and embodiments of the invention, and together with the description, serve to explain the principles of the invention. In the drawings,

FIG. 1 is an exemplary schematic diagram of a computer system according to the present invention;

FIG. 2 is an exemplary flow diagram of a method for adjusting the bus frequency and bus width link on a data bus according to the present invention; and

FIG. 3 is an exemplary detailed flow diagram of a method for adjusting the bus frequency and bus link width on a data bus.

### DETAILED DESCRIPTION OF THE INVENTION

Reference will now be made in detail to the exemplary embodiments of the invention, examples of which are illustrated in the accompanying drawings. Wherever possible, the same reference numbers will be used throughout the drawings to refer to the same. The following techniques provide a method and system for adjusting bus frequency and link width on a bus, which can reduce power consumption in a computing system.

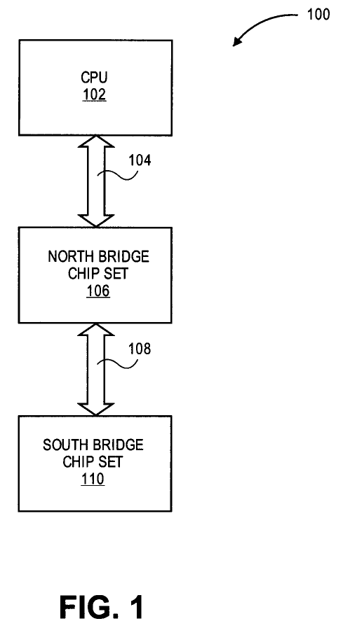

FIG. 1 is an exemplary schematic diagram of a computing system 100 according to the present invention. Referring to FIG. 1, the computing system 100 includes a host bus 104 connected between a CPU 102 and a Northbridge chipset 106. The Northbridge chipset 106 can be connected to a Southbridge chip set 110 via a data bus 108. Although not shown, the Northbridge chipset 106 can interconnect any number of memory devices, data caches, co-processors, and graphic processors to CPU 102 and handle data traffic between such devices. Similarly, Southbridge chipset 110 can interconnect any number of peripheral devices and sub-systems and handle traffic control to the Northbridge chipset 106 for eventual processing by CPU 102. In one example, CPU 102 can be an Advanced Micro Devices (AMD) K8 CPU operating on a HT bus or host bus 104. Other types of CPUs may also be implemented with the techniques disclosed herein.

In one example, a power management driver, such as PowerNow!® developed by AMD, is installed by CPU 102 to monitor the data traffic from and to CPU 102. This information can be used to derive and monitor data traffic parameters for the host bus 104. For example, depending on the current CPU 102 state, the PowerNow driver can monitor the core voltage and frequency of CPU 102 and can be dynamically adjusted for saving power. Here, the core voltage and frequency of CPU 102 could be dynamically adjusted for saving power. The core voltage and frequency of CPU 106 are updated when the VID/FID cycle is asserted by the CPU to the Northbridge chipset 106. In the VID/FID cycle, there is no information about CPU's 102 frequency and voltage for the Northbridge chipset 106 to determine which new frequency and voltage to set for host bus 104. The following examples illustrate how an SMI cycle may be used to wake up basic input output operating system (BIOS) for computing system 100 to adjust the operating frequency and link bandwidth for host bus 102. Although not shown, computing system 100 may include registers that can store the host bust 104 bus frequency and bus link width, and the registers can be accessible to BIOS to implement the host bus operating parameters change.

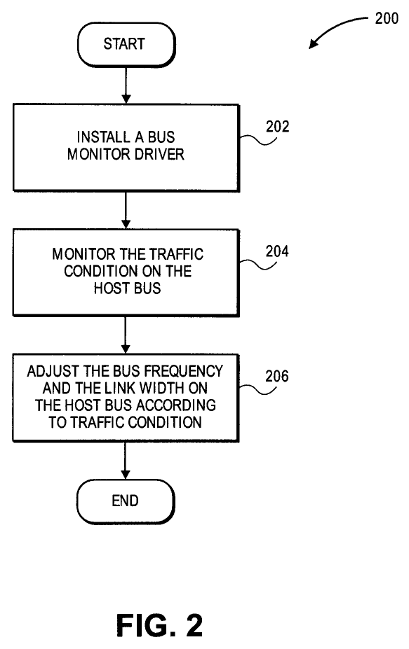

FIG. 2 is an exemplary flow diagram of a method 200 for adjusting the bus frequency and bus width link on a data bus according to the present invention. Initially, a bus monitor driver is installed for a chipset (e.g., Northbridge chipset 106 in computing system 100) (step 202). Such a monitor driver can be the PowerNow!® driver described above. Next, the traffic condition on a host bus (e.g., host bus 104) is monitored (step 204). The bus frequency and link bandwidth for the host bus 104 is adjusted according to the traffic condition on host bus 104 that are monitored in step 203. In certain examples, the bus monitor driver is installed in the Northbridge chipset 106 such that it can monitor the host bus 104 determine if the bus frequency and bus link width should be updated according to the monitored traffic conditions. In certain examples, assume the traffic conditions of the host bus 104 is related to the traffic conditions of CPU 102, in such an instance, the bus frequency and bus link width of the host bus 104 could be adjusted when the CPU 102 asserts a VID/FID cycle. In other examples, the host bus 102 frequency and bus link width can be updated based on the CPU 102 voltage and operating frequency. Normally, because the VID/FID cycle has no information about the CPU 102 voltage and frequency, the Northbridge chipset 106 will not be able to determine the adjustment for the host bus 104 frequency and bus link width during the VID/FID cycle. In these examples, a system management interrupt (SMI) signal is used for the Northbridge chipset 106 to update the values of the host bus 104 frequency and bus link width in the BIOS of computing system 100. For example, the Northbridge chipset 106 can trigger a SMI signal while the VID/FID cycle is issued. The CPU 102 enters into system management mode (SMM) and to awaken the BIOS for computing system 100. While the BIOS it awaken, it can update information in corresponding registers storing bus frequency and bus link width of the host bus 104. After such registers are updated, CPU 102 exits from the SMM, and then the CPU 102 clock is stopped. The host bus 104 is disconnected and then reconnected to run and operate at the updated bus frequency and the bus link width.

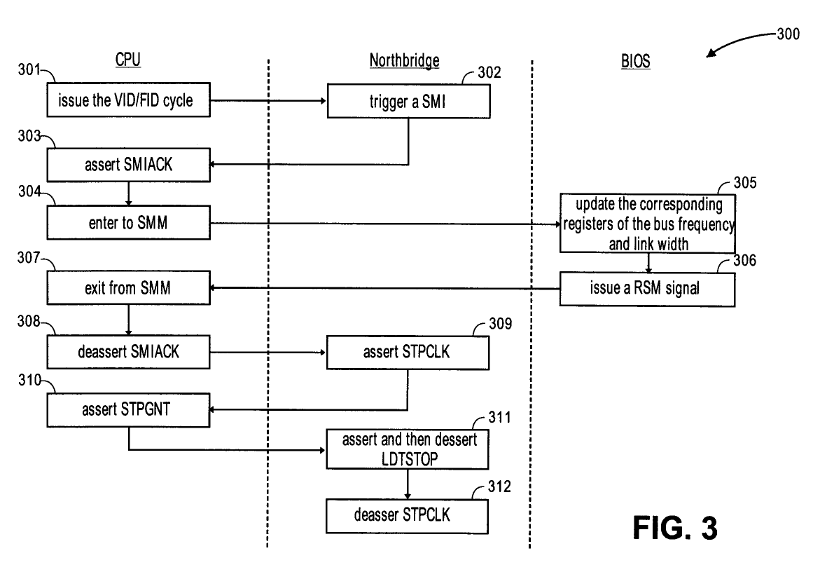

FIG. 3 is an exemplary detailed flow diagram of a method 300 for adjusting the bus frequency and bus link width on a data bus or host bus 104. Initially, the CPU 102 issues the VID/FID cycle to the Northbridge chipset 106 for adjusting the CPU 102 operating voltage and frequency (step 301). Next, the Northbridge chipset 106 triggers a SMI signal to the CPU 102 (step 302). The CPU 102 then asserts a SMIACK signal to the Northbridge chipset 106 to acknowledge receipt of the SMI signal (step 303) and enters into system management mode (SMM) (step 304). The corresponding registers for the host bus 104 frequency and bus link width in BIOS are updated according to the SMI signal (step 305). After the corresponding registers are updated, an RSM signal is issued and CPU 102 exits from the system management mode (SMM) (steps 306 and 307). Then, CPU 102 de-asserts the SMIACK signal and the northbridge 106 asserts a STPCLK signal to CPU 102 for stopping the clock of CPU 102 (steps 308 and 309). The northbridge 106 asserts and then de-asserts a LDTSTOP signal for disconnecting and then reconnecting the host bus 104 after receiving a STPGNT signal from CPU 102 (steps 310 and 311). Finally, the Northbridge chipset 106 de-asserts the STPCLK signal and the CPU 102 and host bus 104 begin operation at the updated conditions (step 312).

As illustrated, the Northbridge chipset 106 is capable of adjusting the operational conditions of a host bus 104. Examples of the above techniques can dynamically change the operation parameters, such as the host bus frequency and the bus link width, according to the state of the bus independently or, in some examples, based on the CPU power management schemes. The present invention may be applied to various systems, such as a computing system using an AMD K8® CPU is one example.

In describing representative examples of the present invention, the specification may have presented the method of the present invention as a particular sequence of steps. However, to the extent that the method does not rely on the particular order of steps set forth herein, the method should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

What is claimed is:

1. A method for adjusting a bus frequency and bus link width of a host bus, the method comprising:
installing a bus monitor driver to a Northbridge chipset;
monitoring traffic conditions of the host bus; and
adjusting the bus frequency and the bus link width of the host bus according to the monitored traffic condition.

2. The method of claim 1, wherein the bus frequency and the bus link width of the host bus are adjusted in accordance with adjusting signal being asserted.

3. The method of claim 2, wherein the adjusting signal is a VID/FID cycle signal.

4. The method of claim 1, further comprising:
triggering a system management interrupt signal; and
updating values for the bus frequency and bus link width of the host bus.

5. The method of claim 4, further comprising:
stopping the clock of the processor;
disconnecting and then reconnecting the host bus; and
operating the host bus at the updated bus frequency and bus link width.

6. The method of claim 1, wherein the host bus is a HyperTransport bus.

7. In a computing system having a Northbridge chipset for adjusting a bus frequency and bus link width of a host bus, wherein the host bus is connected between a processor and the Northbridge chipset, a method comprising:
triggering a system management interrupt signal when an adjusting signal is issued; and
updating the values regarding a bus frequency and bus link width of the host bus.

8. The method of claim 7, wherein the values of the bus frequency and bus link width are stored in registers.

9. The method of claim 7, wherein the adjusting signal is a VID/FID cycle signal.

10. The method of claim 7, wherein the processor enters into a system management mode while the system management interrupt signal is triggered.

11. The method of claim 10, wherein the processor exits from the system management mode while an RSM signal is issued.

12. The method of claim 7, further comprising:
stopping the clock of the processor;
disconnecting and then reconnecting the host bus; and
operating the host bus at the updated bus frequency and the link width.

13. The method of claim 7, wherein the host bus is a HyperTransport bus.

14. A computer system comprising:
a processor;
a Northbridge chipset; and
a host bus connecting the processor to the Northbridge chipset, wherein the Northbridge chipset monitors traffic conditions on the host bus and adjusts at least one of a bus frequency and bus link with of the host bus according to monitored traffic conditions on the host bus.

15. The computer system of claim 14, wherein a bus monitor driver is installed to the Northbridge chipset to monitor the traffic conditions on the host bus.

16. The computer system of claim 14, wherein the Northbridge chipset adjusts the bus frequency and bus link with of the host bus while an adjusting signal is issued.

17. The computer system of claim 16, wherein the adjusting signal is the VID/FID cycle signal.

18. The computer system of claim 14, wherein the Northbridge chipset triggers a system management interrupt signal to update the values of the bus frequency and bus link width of the host bus.

19. The computer system of claim 18, wherein the processor enters into a system management mode while the system management interrupt signal is triggered; and the processor exits form the system management mode after the values of the bus frequency and bus link width of the host bus are updated.

20. The computer system of claim 18, wherein values of the bus frequency and bus link width of the host bus are stored in registers.

21. The computer system of claim 18, wherein the Northbridge chipset stops the clock of the processor and disconnects and then reconnects the host bus after the values of the bus frequency and the link width are updated.

22. The computer system of claim 14, wherein the host bus is a HyperTransport bus.

23. A computer readable medium containing instructions, which if executed by a computing system, operate the system to perform operations comprising:
waking up a basic input output operation system (BIOS) in the computing system;
storing values in one or more registers related to one or more operating parameters for a host bus; and
operating the host bus based on the stored values in the one or more registers.
